(19) United States
(12) Patent Application Publication
(10) Pub. No.: US 2013/0215376 A1
(43) Pub. Date: Aug. 22, 2013

(54) ELECTRONIC SPECTACLES HAVING PARTITIONED SWITCHING LENS

(71) Applicants: Zhiyang GUO, Hercules, CA (US); Peter Si CHANG, Saratoga, CA (US)

(72) Inventors: Zhiyang GUO, Hercules, CA (US); Peter Si CHANG, Saratoga, CA (US)

(21) Appl. No.: 13/401,312

(22) Filed: Feb. 21, 2012

(51) Int. Cl. G02C 7/02

(52) U.S. Cl. 351/159.39

(57) ABSTRACT

Electronic spectacles have a first lens, through which a physical object may be viewed by one eye of a user, having a plurality of zones, each of which having an optical layer arranged in the zone and having an adjustable transmittance; a second lens, through which the physical object may be viewed by another eye of the user, having a plurality of zones, each of which having an optical layer arranged in the zone and having an adjustable transmittance; a controller for respectively adjusting the transmittance of each of the zones of the first and second lenses such that each of the lenses is switched between a viewable status and a masking status; and a communication unit for receiving parameter settings from an external device outside the electronic spectacles to adjust parameters of the controller.

### BACKGROUND

The present disclosure generally relates to ophthalmic spectacles and, more particularly, to electronic spectacles capable of treating eye malfunction, such as strabismus or amblyopia.

Amblyopia (also referred to as “lazy eye”) and strabismus (also referred to as “crossed-eyes”) are two common eye malfunctions. Amblyopia often occurs due to a neural input imbalance of either the optical power of the eyes or ocular misalignment. In amblyopia, the brain primarily relies on vision information from one eye and ignores vision information from the other eye, thereby resulting in a “stronger eye” and a “weaker eye”. One with amblyopia lacks binocular vision and thus the depth perception is impaired. Without timely and proper treatment, loss of vision of the weaker eye may occur.

Strabismus is a vision disorder in which the eyes are not properly aligned with each other. Without proper treatment, strabismus may lead to significant visual problems such as diplopia, loss of depth perception, and amblyopia.

A common technique for treatment of amblyopia and strabismus is patching one eye for a period of time in order to promote the usage of the other eye. Problems with patching are that the patient may not see well when one eye is patched and the patch causes negative social implications.

### SUMMARY

In view of the foregoing, it may be appreciated that a substantial need exists for apparatuses that may mitigate or reduce the problems in the related art.

An example embodiment of electronic spectacles is disclosed comprising: a first lens, through which a physical object may be viewed by one eye of a user, comprising a plurality of zones, each of which comprising an optical layer arranged in the zone and having an adjustable transmittance; a second lens, through which the physical object may be viewed by another eye of the user, comprising a plurality of zones, each of which comprising an optical layer arranged in the zone and having an adjustable transmittance; a controller, coupled with the first and second lenses, for respectively adjusting the transmittance of each of the zones of the first and second lenses such that each of the lenses is switched between a viewable status and a masking status; and a communication unit, coupled with the controller, for receiving parameter settings from an external device outside the electronic spectacles to adjust parameters of the controller.

Another example embodiment of electronic spectacles is disclosed comprising: a wearing element; a first lens, through which a physical object may be viewed by one eye of a user, comprising a plurality of zones, each of which comprising an optical layer arranged in the zone and having an adjustable transmittance; a second lens, through which the physical object may be viewed by another eye of the user, comprising a plurality of zones, each of which comprising an optical layer arranged in the zone and having an adjustable transmittance; a controller, coupled with the first and second lenses, for respectively adjusting the transmittance of each of the zones of the first and second lenses such that each of the lenses is switched between a viewable status and a masking status; a driver circuit, coupled with the first and second lenses, for driving the zones of the first and second lenses under the control of the controller; a power source, coupled with the controller, for providing power to the controller; and a communication unit, arranged in or on the wearing element and coupled with the controller, for receiving parameter settings from an external device outside the electronic spectacles to adjust parameters of the controller.

It is to be understood that both the foregoing general description and the following detailed description are example and explanatory only and are not restrictive of the invention, as claimed.

### BRIEF DESCRIPTION OF THE DRAWINGS

FIG. 1 is a simplified schematic diagram of electronic spectacles for the treatment of eye malfunction in accordance with an example embodiment.

FIG. 2 is a simplified functional block diagram of the control module of FIG. 1 in accordance with an example embodiment.

FIG. 3 is a simplified schematic diagram of electronic spectacles for the treatment of eye malfunction in accordance with another example embodiment.

FIG. 4 is a simplified schematic diagram of electronic spectacles for the treatment of eye malfunction in accordance with another example embodiment.

### DETAILED DESCRIPTION

Reference will now be made in detail to embodiments of the invention, which are illustrated in the accompanying drawings. The same reference numbers may be used throughout the drawings to refer to the same or like parts or components/operations. Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

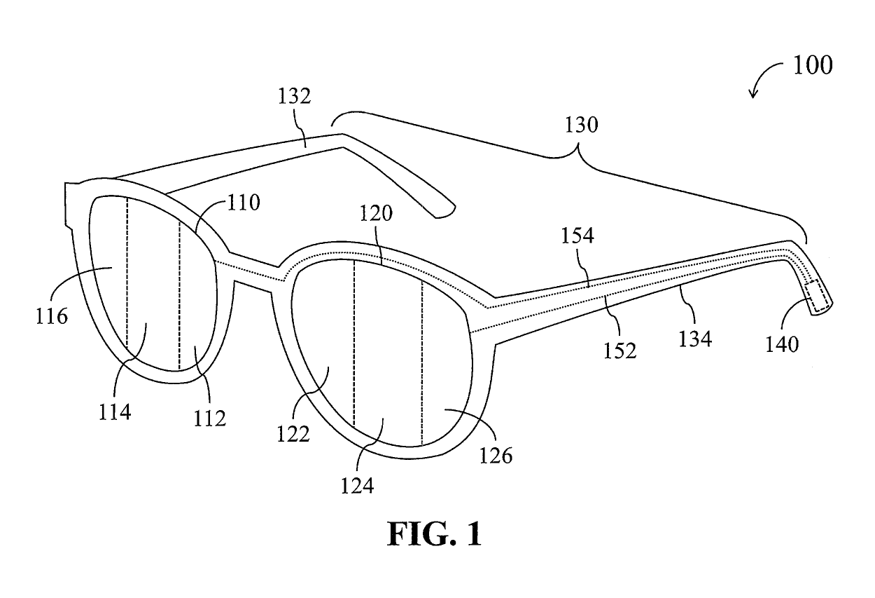

Please refer to FIG. 1, which shows a simplified schematic diagram of electronic spectacles 100 for treatment of eye malfunction, such as amblyopia and strabismus, in accordance with an example embodiment. The electronic spectacles 100 comprise a lens 110, a lens 120, a wearing element 130, and a control module 140. Through the lenses 110 and 120, a physical object may be viewed by respective eyes of the user. Each of the lenses 110 and 120 is partitioned into a plurality of zones. In this embodiment, for example, the lens 110 comprises three zones 112, 114, and 116 arranged side by side, and the lens 120 comprises three zones 122, 124, and 126 arranged side by side. Each of the zones of the lenses 110 and 120 has an adjustable transmittance. For example, each of the zones of the lenses 110 and 120 may comprise an optical layer, such as a liquid crystal layer, arranged in the zone and having an adjustable transmittance. The transmittance of each zone may be adjusted to a desired level by applying appropriate control signals to the liquid crystal layer of the zone.

In the embodiment of FIG. 1, the wearing element 130 comprises a temple 132 connected to the frame of the lens 110 and a temple 134 connected to the frame of the lens 120. The control module 140 is arranged in or on the wearing element 130, such as embedded in the temple 134. In some embodiments, the control module 140 may be embedded in the tip of the temple 134. The control module 140 is coupled with the lenses 110 and 120 to respectively adjust the transmittance of each of the zones of the lenses 110 and 120.

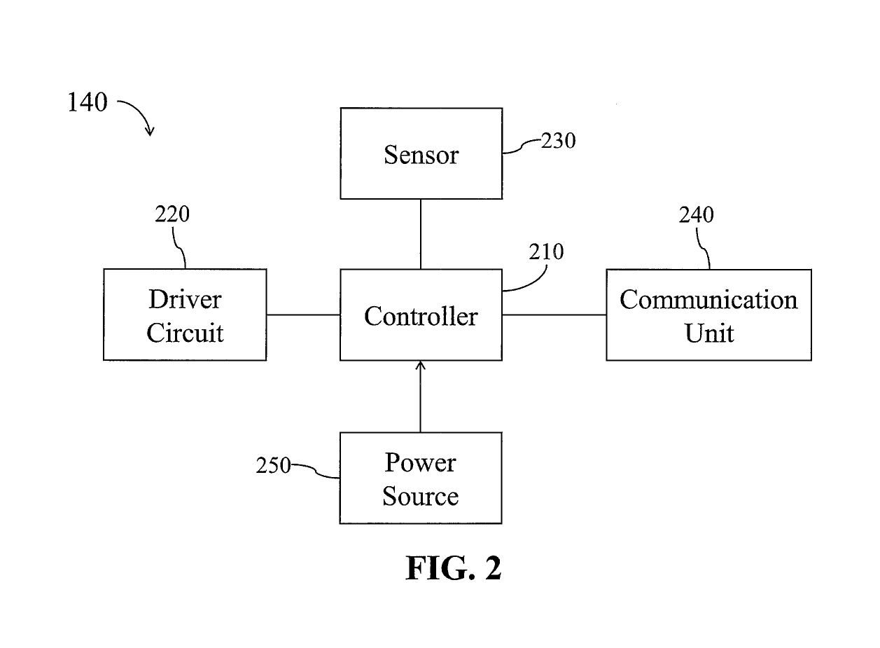

FIG. 2 shows a simplified functional block diagram of the control module 140 in accordance with an example embodiment. As shown in FIG. 2, the control module 140 comprises a controller 210, a driver circuit 220, a sensor 230, a communication unit 240, and a power source 250. The controller 210 is coupled with the driver circuit 220, the sensor 230, the communication unit 240, and the power source 250. The driver circuit 220 is coupled with the lens 110 through a signal path 152 within the temple 134 and is coupled with the lens 120 through a signal path 154 within the temple 134 as shown in FIG. 1. The sensor 230 is utilized for sensing the level of ambient light. The power source 250 provides electricity to the controller 210 and other components. In implementations, the power source 250 may be realized by any suitable power supply device, e.g., a battery or a photocell.

The controller 210 respectively adjusts the transmittance of each of the zones of the lenses 110 and 120 by controlling the driver circuit 220 to drive the zones of the lenses 110 and 120. When the transmittances of more than 90% of zones of a lens are adjusted to be lower than a threshold level, the lens is in a “masking status,” in which the lens is effectively “turned off,” and the eye covered by the lens may not see through the lens under such situation. When the transmittances of more than 90% of zones of the lens are adjusted to be greater than the threshold level, the lens is in a “viewable status,” in which the lens is effectively “turned on”, and the eye covered by the lens may see through the lens.

In one embodiment, the controller 210 may switch only one lens to the viewable status at a time. That is, when the controller 210 switches the lens 110 to the viewable status, the controller 210 would switch the lens 120 to the masking status at the same time. In this situation, only the eye corresponding to the lens 110 is capable of seeing, and the other eye is effectively suppressed. Similarly, when the controller 210 switches the lens 120 to the viewable status, the controller 210 would switch the lens 110 to the masking status at the same time. In this situation, only the eye corresponding to the lens 120 is capable of seeing, and the other eye is effectively suppressed.

The frequency of switching a zone between two distinct transmittance levels is herein referred to as a “switching rate.” The control module 140 may respectively adjust the switching rate of the zones of the lenses 110 and 120. Accordingly, the zones of the lenses 110 and 120 may have the same switching rate, such as 60 Hz or 120 Hz, in the same period. Alternatively, the zones of the lenses 110 and 120 may have different switching rates, such as 60 Hz and 90 Hz, in the same period.

In addition, the controller 210 may change the switch rate of a particular zone from time to time as needed. That is, the controller 210 may configure a zone of the lenses 110 and 120 to have a particular switching rate in a certain period, and then configure the zone to have a different switching rate in another period. For example, the controller 210 may lower the switching rate of one or more zones when the remaining energy of the power source 250 is lower than a threshold degree so as to save power consumption. Therefore, the zones of the lenses 110 and 120 may have different switching rates in some periods and have the same switching rate in other periods, such as the power-saving period.

The communication unit 240 is utilized for receiving parameter settings from an external device outside the electronic spectacles 100 to adjust parameters of the controller 210. The communication unit 240 may receive the parameter settings from the external device through a wired interface or a wireless communication link. For example, the communication unit 240 may receive the parameter settings for configuring the adjusting process of the transmittances and/or the switching rates of the lenses 110 and 120. In implementations, the external device may be a computer, a smart phone, a remote controller, or other communication device operated by an ophthalmic practitioner or an adequate person, such as the parent of a child with eye malfunction under the ophthalmic practitioner's instruction. In this way, the electronic spectacles 100 may be configured to operate at different modes in different therapy stages to satisfy different requirements in a long-term therapy process. The operations of the electronic spectacles 100 will be further described in the following.

For the purpose of explanatory convenience, it is assumed that the lens 110 is utilized for the defect eye (i.e., the weaker eye in the case of amblyopia or the crossed eye in the case of strabismus) and the lens 120 is utilized for the other eye (i.e., the stronger eye in the case of amblyopia or the normal eye in the case of strabismus).

In a certain period of the treatment of amblyopia or strabismus, such as an early stage of the treatment, the controller 210 may repeatedly adjust the transmittance of each of the zones of the lenses 110 and 120 such that each of the lenses 110 and 120 is switched between the viewable status and the masking status. In this stage, the accumulated time of switching the lens 110 to the viewable status is less than that of the lens 120. For example, the controller 210 may switch the lens 110 to the viewable status for 40% of time and switch the lens 120 to the viewable status for 60% of time. In this way, the usage of the defect eye is promoted, but not too aggressively, avoiding the patient to completely rely on the defect eye in this stage.

When the defect eye gets some improvements and the patient gets used to the operations of the electronic spectacles 100, the ophthalmic practitioner or the adequate person may adjust the parameters of the controller 210 via the communication unit 240.

For example, in another period of the treatment, such as a middle stage of the treatment, the controller 210 may repeatedly adjust the transmittance of each of the zones of the lenses 110 and 120 such that each of the lenses 110 and 120 is switched between the viewable status and the masking status, but the accumulated time of switching the lens 110 to the viewable status is more than that of the lens 120. For example, the controller 210 may switch the lens 110 to the viewable status for 60% of time and switch the lens 120 to the viewable status for 40% of time in this stage. In this way, the usage of the defect eye may be further promoted.

In another period of the treatment, such as a later stage of the treatment, the controller 210 may repeatedly adjust the transmittance of each of the zones of the lenses 110 and 120 such that each of the lenses 110 and 120 is switched between the viewable status and the masking status, and the accumulated time of switching the lens 110 to the viewable status is substantially equal to that of the lens 120. For example, the controller 210 may switch the lens 110 to the viewable status for 50% of time and switch the lens 120 to the viewable status for the rest 50% of time. This may be helpful for the patient with amblyopia or strabismus to develop better depth perception as the usage of both eyes is balanced.

The controller 210 may also configure different zones of a particular lens to have different transmittances when the lens is switched to the viewable status. In the treatment of some patients, for example, the controller 210 may configure the zone 114 of the lens 110 to have a transmittance greater than the transmittance of the zone 116, and configure the zone 112 to have a transmittance greater than the transmittance of the zone 114 when the lens 110 is in the viewable status. For some patients, the controller 210 may configure the zone 114 of the lens 110 to have a transmittance greater than the transmittance of the zone 112, and configure the zone 116 to have a transmittance greater than the transmittance of the zone 114 when the lens 110 is in the viewable status. Such transmittance arrangement is helpful to some patient in the treatment of strabismus, and/or amblyopia.

As may be interfered from the foregoing descriptions, a particular zone of a lens may have a transmittance different from that of another zone of another lens in the same period. For example, the zone 112 of the lens 110 may have a transmittance different from that of the zone 216 of the lens 120 in the same therapy stage.

In addition, the controller 210 may change the transmittance of a particular zone of a lens from time to time as needed. That is, the controller 210 may configure one or more zones of a particular lens to have a particular transmittance in a certain period, and configure those zones to have a different transmittance in another period. For example, after the patient had an ophthalmic surgery on the defect eye, the controller 210 may configure the zones 112-116 of the lens 110 to have a low transmittance in a recovery period, such as couple days, and then configure the zones 112-116 of the lens 110 to have a higher transmittance after the recovery period.

In some embodiments, the controller 210 may adjust the transmittance of some or all the zones of the lenses 110 and 120 according to the level of ambient light detected by the sensor 230 to provide better protection to the eyes. For example, the controller 210 may lower the transmittance of all the zones of the lenses 110 and 120 when the user wearing the electronic spectacles 100 goes to a brighter place, such as to an outdoor activity.

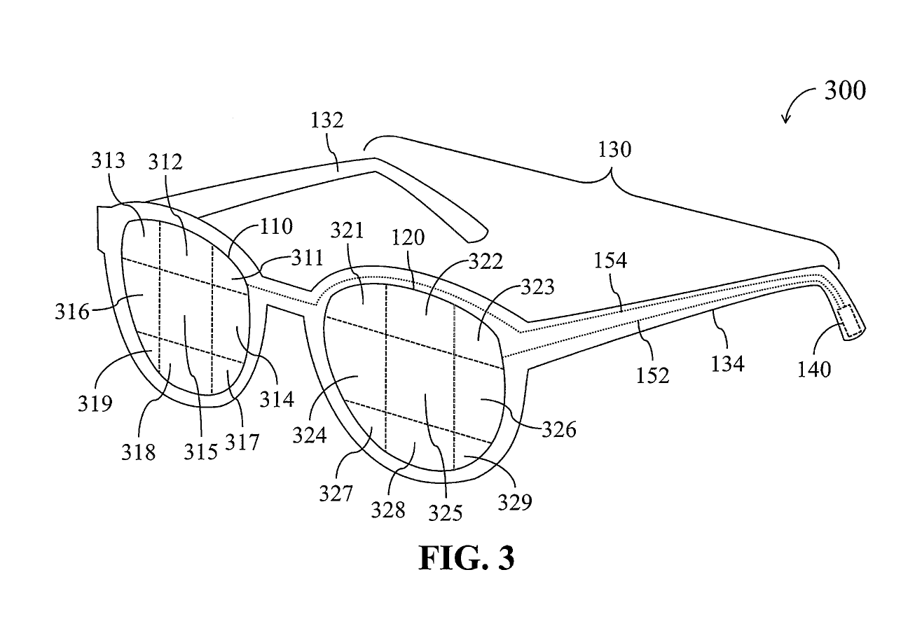

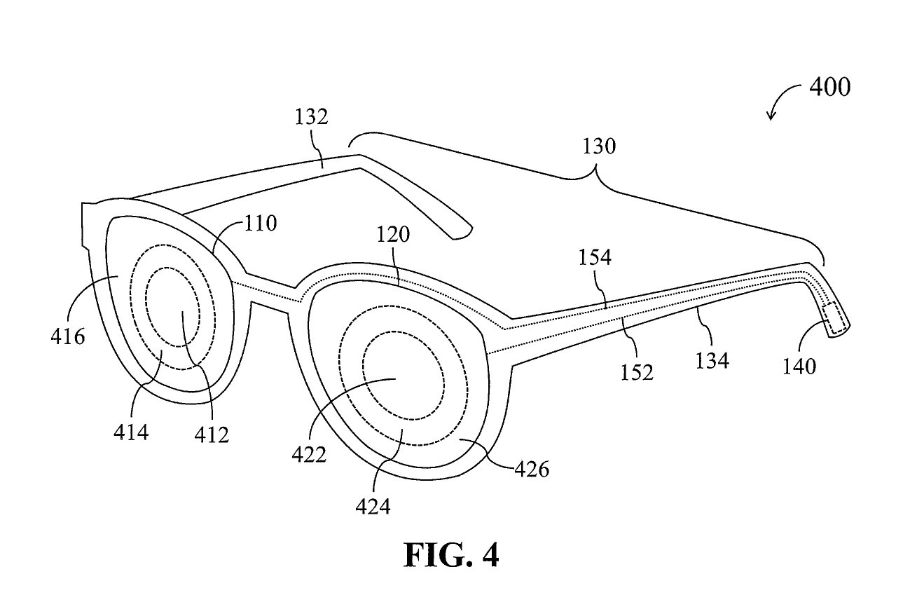

The number and partition of the zones of the lenses shown in FIG. 1 is merely an example, rather than a restriction to the practical implementations. Based on various purposes, each of the lenses 110 and 120 may be partitioned into multiple zones with other approaches. For example, FIG. 3 shows a simplified schematic diagram of electronic spectacles 300 for the treatment of eye malfunction in accordance with another example embodiment, and FIG. 4 shows a simplified schematic diagram of electronic spectacles 400 for the treatment of eye malfunction in accordance with yet another ex- ample embodiment. In the embodiment shown in FIG. 3, the lens 110 is partitioned into nine zones 311-319 and the lens 120 is partitioned in to nine zones 321-329. As illustrated, the zones 311, 312, and 313 of the lens 110 are arranged horizontally, and the zones 312, 315, and 318 are arranged vertically. Similarly, the zones 327, 328, and 329 of the lens 120 are arranged horizontally, and the zones 323, 326, and 329 are arranged vertically. In the embodiment shown in FIG. 4, the lens 110 is partitioned into three zones 412, 414, and 416 arranged concentrically, and the lens 120 is partitioned into three zones 422, 424, and 426 arranged concentrically. As illustrated above, the zones of the lenses 110 and 120 may have the same or different shapes and areas.

In the previous embodiments, the wearing element 130 of the electronic spectacles 100 comprises two temples 132 and 134. This is merely an example, rather than a restriction to the practical implementations. For example, the wearing element 130 may be instead realized with a strap, and the control module 140 may be embedded in the strap.

In implementations, the optical layer of each zone of the lenses 110 and 120 may be realized with other materials instead of liquid crystal. For example, the optical layer may be a layer containing multiple polymeric particles which are rotatable under the control of the driver circuit 220 to redirect the light passing through the polymeric particles. The controller 210 may adjust the transmittance of the optical layer formed by polymeric particles by controlling the driver circuit 220 to rotate those polymeric particles.

As may be seen from the foregoing elaborations, the electronic spectacles disclosed above do not completely block out either eye during the treatment, thus the patient would have a better vision throughout the treatment, thereby mitigating the patient's resistance in the early stage of the treatment. In addition, the social implication problems caused by the use of traditional eye patches is significantly reduced or eliminated by replacing the eye patch with the electronic spectacles disclosed above. As a result, the acceptance of the treatment would be greatly increased and thereby improving the successful rate of the treatment of amblyopia and strabismus.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. Electronic spectacles, comprising:
a first lens, through which a physical object may be viewed by one eye of a user, comprising a plurality of zones, each of which comprising an optical layer arranged in the zone and having an adjustable transmittance;
a second lens, through which the physical object may be viewed by another eye of the user, comprising a plurality of zones, each of which comprising an optical layer arranged in the zone and having an adjustable transmittance;
a controller, coupled with the first and second lenses, for respectively adjusting the transmittance of each of the zones of the first and second lenses such that each of the zones is switched between a viewable status and a masking status; and
a communication unit, coupled with the controller, for receiving parameter settings from an external device outside the electronic spectacles to adjust parameters of the controller.

2. The electronic spectacles of claim 1, wherein the optical layer of each zone is a liquid crystal layer or a layer containing multiple polymeric particles which are rotatable under the control of the controller.

3. The electronic spectacles of claim 2, further comprise:
a driver circuit, coupled with the first and second lenses, for driving the zones of the first and second lenses under the control of the controller.

4. The electronic spectacles of claim 3, further comprise:
a sensor, coupled with the controller, for detecting the level of ambient light;
wherein the controller adjusts the transmittance of at least one of the zones of the first and second lenses according to the detection result of the sensor.

5. The electronic spectacles of claim 4, wherein the plurality of zones of the first lens are arranged in the first lens concentrically, horizontally, or vertically.

6. The electronic spectacles of claim 5, wherein the communication unit receives the parameter settings from the external device through a USB interface or a wireless communication link.

7. The electronic spectacles of claim 6, wherein the controller is arranged in or on a temple tip of the electronic spectacles.

8. The electronic spectacles of claim 1, wherein the controller configures a first zone of the first lens to have a first transmittance and configures a second zone of the first lens to have a second transmittance in a first predetermined period, wherein the first transmittance and the second transmittance are different.

9. The electronic spectacles of claim 8, wherein the controller configures the first zone to have a third transmittance in a second predetermined period;
wherein the first transmittance and the third transmittance are different.

10. The electronic spectacles of claim 1, wherein the controller configures a first zone of the first lens to have a first transmittance in a first predetermined period and configures the first zone to have a second transmittance in a second predetermined period, wherein the first transmittance and the second transmittance are different.

11. The electronic spectacles of claim 1, wherein the controller configures a first zone of the first lens and a second zone of the second lens to have different transmittances or different switching rates in a first predetermined period.

12. The electronic spectacles of claim 1, wherein the controller configures a first zone of the first and second lenses to have a first switching rate in a first predetermined period, configures a second zone of the first and second lenses to have a second switching rate in the first predetermined period, and configures the first zone to have a third switching rate in a second predetermined period;
wherein the first switching rate, the second switching rate, and the third switching rate are different.

13. The electronic spectacles of claim 1, wherein accumulated time of the first lens switched in the viewable status is less than that of the second lens in a first predetermined period, and accumulated time of the first lens switched in the viewable status is greater than that of the second lens in a second predetermined period.

14. The electronic spectacles of claim 13, wherein accumulated time of the first lens switched in the viewable status in the first predetermined period is less than accumulated time of the first lens switched in the viewable status in the second predetermined period.

15. The electronic spectacles of claim 1, wherein accumulated time of the first lens switched in the viewable status in the first predetermined period is less than accumulated time of the first lens switched in the viewable status in the second predetermined period.

16. Electronic spectacles, comprising:
a wearing element;
a first lens, through which a physical object may be viewed by one eye of a user, comprising a plurality of zones, each of which comprising an optical layer arranged in the zone and having an adjustable transmittance;
a second lens, through which the physical object may be viewed by another eye of the user, comprising a plurality of zones, each of which comprising an optical layer arranged in the zone and having an adjustable transmittance;
a controller, coupled with the first and second lenses, for respectively adjusting the transmittance of each of the zones of the first and second lenses such that each of the zones is switched between a viewable status and a masking status;
a driver circuit, coupled with the first and second lenses, for driving the zones of the first and second lenses under the control of the controller;
a power source, coupled with the controller, for providing power to the controller; and
a communication unit, arranged in or on the wearing element and coupled with the controller, for receiving parameter settings from an external device outside the electronic spectacles to adjust parameters of the controller.

17. The electronic spectacles of claim 16, wherein the controller configures a first zone of the first lens to have a first transmittance and configures a second zone of the first lens to have a second transmittance in a first predetermined period, wherein the first transmittance and the second transmittance are different.

18. The electronic spectacles of claim 17, wherein the controller configures the first zone to have a third transmittance in a second predetermined period;
wherein the first transmittance and the third transmittance are different.

19. The electronic spectacles of claim 16, wherein accumulated time of the first lens switched in the viewable status is less than that of the second lens in a first predetermined period, and accumulated time of the first lens switched in the viewable status is greater than that of the second lens in a second predetermined period.

20. The electronic spectacles of claim 19, wherein accumulated time of the first lens switched in the viewable status in the first predetermined period is less than accumulated time of the first lens switched in the viewable status in the second predetermined period.
